(19) United States
(12) Patent Application Publication
(10) Pub. No.: US 2026/0017986 A1
(43) Pub. Date: Jan. 15, 2026

(54) Fingerprint data processing method, host device and wireless device with encrypted communications

(71) Applicant: Realtek Semiconductor Corp., HsinChu (TW)

(72) Inventors: BAOHUI ZHAO, Suzhou City (CN); YANG LI, Suzhou City (CN); Yu-Ta Chen, HsinChu (TW)

(73) Assignee: Realtek Semiconductor Corp., HsinChu (TW)

(21) Appl. No.: 19/240,001

(22) Filed: Jun. 17, 2025

(30) Foreign Application Priority Data
Jul. 9, 2024 (CN) 202410916817.7

(51) Int. Cl. G06V 40/50; G06V 10/74; G06V 10/94; G06V 40/12; H04W 4/80; H04W 12/03; H04W 12/06

(52) U.S. Cl. CPC G06V 40/50; G06V 10/74; G06V 10/94; G06V 40/1365; H04W 4/80; H04W 12/03; H04W 12/06

(57) ABSTRACT

A fingerprint data processing method is used for a wireless communication system including a host device and a wireless device, which communicate through a wireless communication interface. The method includes steps of: generating, by the host device, a fingerprint recognition command; driving, by the host device, a first wireless communication circuit to transmit a fingerprint recognition request to the wireless device through the wireless communication interface according to the fingerprint recognition command; receiving, by the wireless device, the fingerprint recognition request through the wireless communication interface, and obtaining, by the wireless device, fingerprint data according to the fingerprint recognition request; driving, by the wireless device, a second wireless communication circuit to transmit the fingerprint data to the host device through the wireless communication interface. The wireless communication interface forwards at least one of the fingerprint recognition request and the fingerprint data using an encrypted communication protocol.

### BACKGROUND OF THE INVENTION

### 1. Field of the Invention

The present invention relates to a fingerprint data processing method, and more particularly, to a fingerprint data processing method capable of transmitting fingerprint data through a wireless communication interface and a related host device and wireless device.

### 2. Description of the Prior Art

With the continuous development of information technology, personal information security has attracted more and more attention. Conventional identity authentication methods, such as user passwords or dynamic instructions, have security risks as being easily stolen and easily cracked. As a new method of identity verification, biometric authentication technology has higher security and reliability, so it has been widely used. Fingerprint recognition technology has become one of the most widely used biometric authentication technologies because of its uniqueness, stability, and ease of collection. However, conventional wired fingerprint recognition authentication technology still has some problems, such as the security of fingerprint information transmission, device compatibility, and user convenience. In order to solve the problems of device compatibility and user convenience, the industry has developed a wireless mobile fingerprint recognition authentication technology. However, there are still several problems that fingerprint information transmission is unsafe and easy to be attacked by hackers.

### SUMMARY OF THE INVENTION

It is therefore an objective of the present invention to provide a solution to the security authentication technology for wireless fingerprint recognition. The solution applies Bluetooth to deliver fingerprint data to reduce power consumption of data transmission. In addition, the present invention applies an encrypted communication protocol to protect the transmitted fingerprint data/information, effectively avoiding information leakage and tampering.

An embodiment of the present invention discloses a fingerprint data processing method. The fingerprint data processing method is used for a wireless communication system. The wireless communication system comprises a host device and a wireless device, which communicate with each other through a wireless communication interface. The fingerprint data processing method comprises steps of: generating, by the host device, a fingerprint recognition command; driving, by the host device, a first wireless communication circuit to transmit a fingerprint recognition request to the wireless device through the wireless communication interface according to the fingerprint recognition command; receiving, by the wireless device, the fingerprint recognition request through the wireless communication interface, and obtaining, by the wireless device, fingerprint data according to the fingerprint recognition request; and driving, by the wireless device, a second wireless communication circuit to transmit the fingerprint data to the host device through the wireless communication interface. The wireless communication interface forwards at least one of the fingerprint recognition request and the fingerprint data using an encrypted communication protocol.

Another embodiment of the present invention discloses a host device, which comprises a fingerprint driver, a wireless communication circuit and a protocol converter. The fingerprint driver is configured to generate a fingerprint recognition command. The wireless communication circuit is configured to transmit a fingerprint recognition request through a wireless communication interface and receive fingerprint data through the wireless communication interface. The protocol converter, coupled between the fingerprint driver and the wireless communication circuit, is configured to drive the wireless communication circuit to output the fingerprint recognition request according to the fingerprint recognition command. The wireless communication interface forwards at least one of the fingerprint recognition request and the fingerprint data using an encrypted communication protocol.

Another embodiment of the present invention discloses a wireless device, which comprises a wireless communication circuit and a fingerprint circuit. The wireless communication circuit is configured to receive a fingerprint recognition request through a wireless communication interface and transmit fingerprint data through the wireless communication interface. The fingerprint circuit, coupled to the wireless communication circuit, is configured to generate the fingerprint data according to the fingerprint recognition request and transmit the fingerprint data to the wireless communication circuit. The wireless communication interface forwards at least one of the fingerprint recognition request and the fingerprint data through an encrypted communication protocol.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the present invention.

FIG. 2 illustrates a specific application of the wireless communication system.

FIG. 3 is a flowchart of a fingerprint data processing process according to an embodiment of the present invention.

FIG. 4 illustrates a signal delivery process of the wireless communication system applying the MOH scheme.

FIG. 5 illustrates a signal delivery process of the wireless communication system applying the MOC scheme.

### DETAILED DESCRIPTION

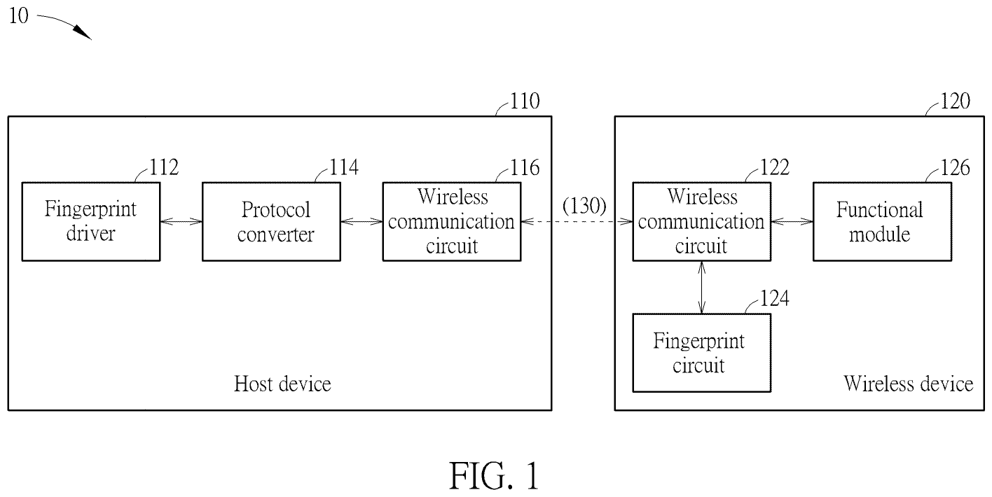

FIG. 1 is a schematic diagram of a wireless communication system 10 according to an embodiment of the present invention. The wireless communication system 10 includes a host device 110 and a wireless device 120, which communicate with each other through a wireless communication interface 130. The wireless communication system 10 has fingerprint recognition functions, where the wireless device 120 may read the fingerprint of a user, and transmit related fingerprint data to the host device 110 for subsequent processing. In an embodiment, the wireless communication interface 130 may be a Bluetooth interface, which uses the Bluetooth technology for transmissions of wireless fingerprint data, possessing the benefit of low power consumption. In addition, the wireless communication interface 130 may forward the fingerprint data and/or related information by using an encrypted communication protocol to avoid the attack of hackers. In an embodiment, the encrypted communication protocol applied may be the Secure Device Connection Protocol (SDCP), which may encrypt the transmitted fingerprint data/information to achieve a protective effect.

The host device 110 includes a fingerprint driver 112, a protocol converter 114 and a wireless communication circuit 116. The fingerprint driver 112 is configured to generate a fingerprint recognition command. For example, when a user needs to perform a specific function and the function requires identity authentication, the fingerprint driver 112 may output a fingerprint recognition command to drive the wireless communication circuit 116 to transmit a fingerprint recognition request through the wireless communication interface 130. After the host device 110 receives the fingerprint data from the wireless device 120, the fingerprint driver 112 may also perform various operations such as fingerprint enrollment and authentication unlock based on the fingerprint data. In an embodiment, the host device 110 is a computer host applying the Windows operating system, and thus the fingerprint driver 112 may be a driver developed based on Windows Biometric Framework (WBF), which may be used to analyze the operation instructions of the operating system, to encrypt the commands associated with fingerprint recognition and then send the commands to the protocol converter 114 and the wireless communication circuit 116.

The protocol converter 114, which is coupled between the fingerprint driver 112 and the wireless communication circuit 116, may drive the wireless communication circuit 116 to output a fingerprint recognition request according to the fingerprint recognition command. In an embodiment, the host device 110 may be a computer host applying the Windows operating system, and thus the protocol converter 114 may be a driver developed based on Windows Driver Framework (WDF), which is responsible for receiving the fingerprint recognition command from the fingerprint driver 112, converting the fingerprint recognition command into the fingerprint recognition request complying with the specification of the wireless communication circuit 116, and then sending the fingerprint recognition request to the wireless communication circuit 116. The protocol converter 114 may also correspondingly receive the fingerprint data from the wireless communication circuit 116, and perform processing and conversion on the fingerprint data and then send the fingerprint data to the fingerprint driver 112.

The wireless communication circuit 116 may transmit the fingerprint recognition request through the wireless communication interface 130 according to the fingerprint recognition command from the fingerprint driver 112. In addition, the wireless communication circuit 116 may also correspondingly receive the fingerprint data from the wireless device 120 through the wireless communication interface 130. In an embodiment, since the wireless communication interface 130 is a Bluetooth interface, the wireless communication circuit 116 may be a Bluetooth control circuit.

The wireless device 120 includes a wireless communication circuit 122, a fingerprint circuit 124 and a functional module 126. The wireless communication circuit 122 may receive the fingerprint recognition request from the host device 110 through the wireless communication interface 130. In addition, the wireless communication circuit 122 may also correspondingly transmit the fingerprint data to the host device 110 through the wireless communication interface 130. In an embodiment, since the wireless communication interface 130 is a Bluetooth interface, the wireless communication circuit 122 may be a Bluetooth control circuit.

The fingerprint circuit 124, which is coupled to the wireless communication circuit 122, may generate the fingerprint data according to the fingerprint recognition request, and transmit the fingerprint data to the wireless communication circuit 122. In detail, the fingerprint circuit 124 may include a fingerprint sensor or may be coupled to a fingerprint sensor, where the fingerprint sensor performs fingerprint collection to obtain a fingerprint image. The fingerprint circuit 124 may further perform fingerprint recognition and authentication on the fingerprint image to obtain an authentication result. Alternatively, the fingerprint circuit 124 may transmit the fingerprint image as the fingerprint data to the host device 110, where the fingerprint driver 112 of the host device 110 performs fingerprint recognition and authentication to obtain an authentication result.

The functional module 126 may be configured to implement specific application functions of the wireless device 120. For example, if the wireless device 120 is a wireless mouse, the functional module 126 is configured to execute various functions required for mouse operations. In other embodiments, the wireless device 120 may be or include a wireless keyboard and/or other computer peripherals, which are used for implementing various operations with the host device 110 (e.g., a computer host) through the wireless communication interface 130.

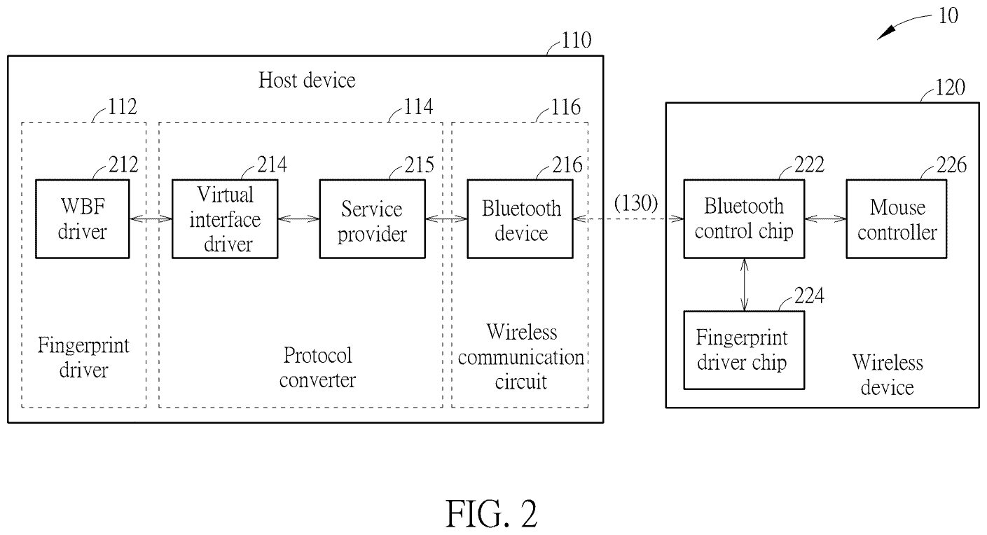

FIG. 2 illustrates a specific application of the wireless communication system 10. In this embodiment, the host device 110 is a computer using the Windows operating system, where the fingerprint driver 112 includes a WBF driver 212; the protocol converter 114 includes a virtual interface driver 214 and a service provider 215; and the wireless communication circuit 116 includes a Bluetooth device 216. In another embodiment, the wireless communication circuit 116 and the Bluetooth device 216 may be integrated with the protocol converter 114.

The fingerprint driving currently used in the Windows operating system is mainly implemented through the universal serial bus (USB) interface; that is, the fingerprint recognition request is delivered to the peripheral devices through the USB interface. Therefore, the fingerprint recognition command output by the WBF driver 212 is mainly generated for USB applications. However, the transmission interface used in the present invention is the wireless communication interface. Under the current fingerprint driving architecture, the fingerprint recognition functions of the WBF driver 212 are still applicable, but an additional protocol converter 114 needs to be incorporated to convert the commands related to current USB interface into the commands that comply with the specification of the wireless communication circuit 116 (e.g., the Bluetooth device 216).

In this embodiment, the virtual interface driver 214 is configured to generate a virtual interface built in the operating system of the host device 110. The service provider 215 may communicate with the Bluetooth device 216 in the wireless communication circuit 116 through the virtual interface, to transmit the fingerprint recognition command from the WBF driver 212 to the Bluetooth device 216 through the virtual interface. The Bluetooth device 216 may thereby output the fingerprint recognition request according to the fingerprint recognition command. In the programming architecture of the Windows operating system, the virtual interface driver 214 may be a USB Device Emulation (UDE) driver for generating a virtual USB interface. Through the virtual USB interface, the service provider 215 may communicate with the Bluetooth device 216 based on the Bluetooth Generic Attribute Profile (GATT).

In another embodiment, the protocol converter 114 may also be integrated with the fingerprint driver 112, so that the wireless communication circuit 116 is directly driven by the fingerprint driver 112 to output the fingerprint recognition request. In such a situation, the fingerprint driver 112 may output a command complying with the specification of the wireless communication circuit 116 to perform driving without through another virtual interface.

Please continue to refer to FIG. 2. Correspondingly, in the wireless device 120, the wireless communication circuit may be or include a Bluetooth control chip 222, and the fingerprint circuit may be or include a fingerprint driver chip 224. In this embodiment, the wireless device 120 is a wireless mouse, and thus the functional module may be a mouse controller 226. Correspondingly, the Bluetooth control chip 222 and the fingerprint driver chip 224 may also communicate with each other through the same Bluetooth communication protocol (such as the Bluetooth GATT). For example, the Bluetooth control chip 222 may convert the fingerprint recognition request into a command recognizable by the fingerprint driver chip 224, to control the fingerprint driver chip 224 to perform operations such as fingerprint collection and recognition.

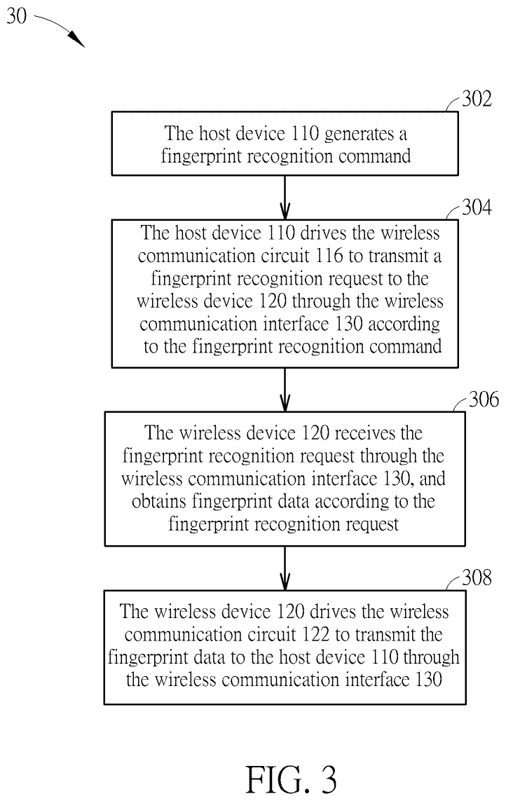

FIG. 3 is a flowchart of a fingerprint data processing process 30 according to an embodiment of the present invention. The fingerprint data processing process 30 may be used for a wireless communication system (such as the wireless communication system 10 in FIG. 1 or FIG. 2), for specifying the operations performed by the host device 110 and the wireless device 120. As shown in FIG. 3, the fingerprint data processing process 30 includes the following steps:
Step 302: The host device 110 generates a fingerprint recognition command.
Step 304: The host device 110 drives the wireless communication circuit 116 to transmit a fingerprint recognition request to the wireless device 120 through the wireless communication interface 130 according to the fingerprint recognition command.
Step 306: The wireless device 120 receives the fingerprint recognition request through the wireless communication interface 130, and obtains fingerprint data according to fingerprint recognition request.
Step 308: The wireless device 120 drives the wireless communication circuit 122 to transmit the fingerprint data to the host device 110 through the wireless communication interface 130.

According to the fingerprint data processing process 30, the operating system of the host device 110 needs to perform fingerprint enrollment or authentication by receiving a notification from a specific application, and sends the enrollment or authentication notification to the fingerprint driver 112. The fingerprint driver 112 may generate the fingerprint recognition command correspondingly. Subsequently, the protocol converter 114 drives the wireless communication circuit 116 to transmit the fingerprint recognition request through the wireless communication interface 130 according to the fingerprint recognition command. After the fingerprint recognition request is received by the wireless communication circuit 122 in the wireless device 120, the wireless communication circuit 122 may send related messages to notify the fingerprint circuit 124 in the wireless device 120. Accordingly, the fingerprint circuit 124 may perform corresponding fingerprint operations, such as fingerprint image collection and fingerprint recognition, to obtain fingerprint data. Subsequently, the wireless communication circuit 122 transmits the fingerprint data to the host device 110 through the wireless communication interface 130. The fingerprint driver 112 thereby performs subsequent operations according to the fingerprint data.

The fingerprint data processing process 30 of the present invention may apply the Match-on-Host (MOH) or Match-on-Chip (MOC) scheme. In the MOH scheme, the operations of fingerprint analysis and matching are performed in the host device 110; that is, the fingerprint driver 112 of the host device 110 is responsible for matching fingerprint images to perform authentication, and/or for identifying and storing the fingerprint image in the enrollment process.

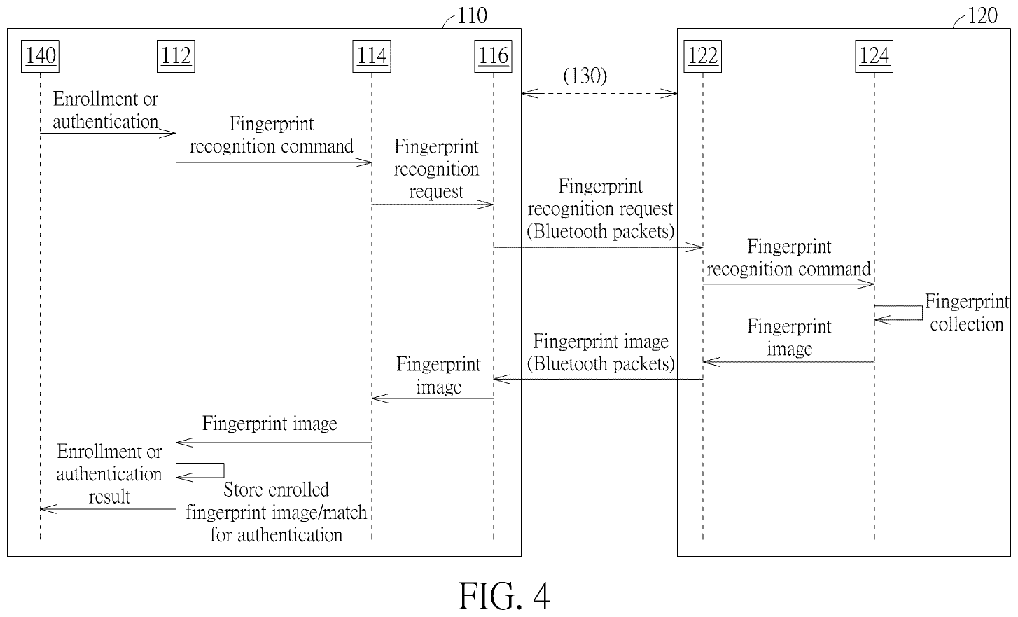

FIG. 4 illustrates a signal delivery process of the wireless communication system 10 applying the MOH scheme. First, an operating system 140 of the host device 110 transmits an enrollment or authentication request to the fingerprint driver 112. The fingerprint driver 112 sends the corresponding fingerprint recognition command to the protocol converter 114 accordingly. Subsequently, the protocol converter 114 converts the fingerprint recognition command into a fingerprint recognition request complying with the Bluetooth protocol. The wireless communication circuit 116 then transmits the fingerprint recognition request with Bluetooth packets, which are delivered to the wireless device 120 through the wireless communication interface 130. After receiving the fingerprint recognition request, the wireless communication circuit 122 may convert the fingerprint recognition request into the fingerprint recognition command and transmit the fingerprint recognition command to the fingerprint circuit 124. According to the fingerprint recognition command, the fingerprint circuit 124 may perform fingerprint collection by using a fingerprint sensor and obtain a fingerprint image. The data associated with the fingerprint image may be transmitted to the fingerprint driver 112 through the wireless communication circuit 122, the wireless communication circuit 116 and the protocol converter 114.

If the operating system transmits an enrollment request, the fingerprint driver 112 may store the received fingerprint image as an enrolled fingerprint image. The enrolled fingerprint image may be stored with a user identifier (ID) as a fingerprint enrollment result, to be used for subsequent fingerprint matching operations. The fingerprint driver 112 then transmits the fingerprint enrollment result to the operating system, to complete the fingerprint enrollment process.

On the other hand, if the operating system transmits an authentication request, the fingerprint driver 112 may match (or compare) the received fingerprint image with a previously enrolled fingerprint image to generate an authentication result. If the fingerprint is correct, the fingerprint driver 112 may transmit the authentication result (which may include the corresponding user ID) to the operating system 140, to be provided to related applications for subsequent operations. In contrast, if the fingerprint is wrong, the fingerprint driver 112 may also transmit the authentication result to the operating system 140.

In the MOC scheme, the operations of fingerprint analysis and matching are performed in the wireless device 120; that is, in addition to performing fingerprint collection, the fingerprint circuit 124 of the wireless device 120 is also responsible for matching fingerprint images to performing authentication, and/or for identifying and storing the fingerprint image in the enrollment process.

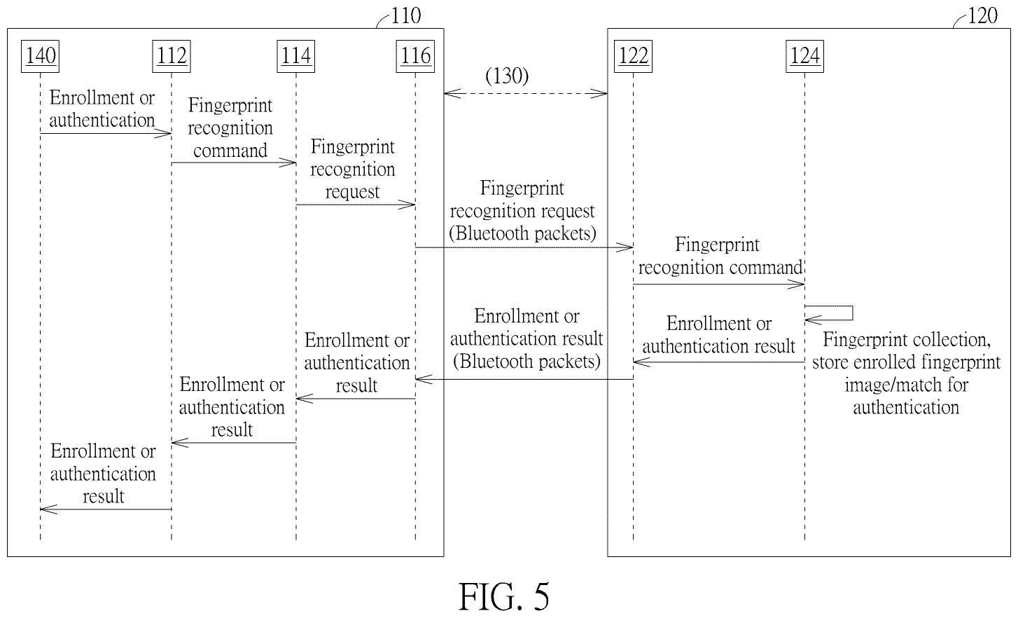

FIG. 5 illustrates a signal delivery process of the wireless communication system 10 applying the MOC scheme. First, the operating system 140 of the host device 110 transmits an enrollment or authentication request to the fingerprint driver 112. The fingerprint driver 112 sends the corresponding fingerprint recognition command to the protocol converter 114 accordingly. Subsequently, the protocol converter 114 converts the fingerprint recognition command into a fingerprint recognition request complying with the Bluetooth protocol. The wireless communication circuit 116 then transmits the fingerprint recognition request with Bluetooth packets, which are delivered to the wireless device 120 through the wireless communication interface 130. After receiving the fingerprint recognition request, the wireless communication circuit 122 may convert the fingerprint recognition request into the fingerprint recognition command and transmit the fingerprint recognition command to the fingerprint circuit 124. According to the fingerprint recognition command, the fingerprint circuit 124 may perform fingerprint collection by using a fingerprint sensor and obtain a fingerprint image, and perform the operations of enrollment, matching and authentication on the obtained fingerprint image.

If the operating system transmits an enrollment request, the fingerprint circuit 124 may store the collected fingerprint image as an enrolled fingerprint image. The enrolled fingerprint image may be stored with a user ID, to be used for subsequent fingerprint matching operations. The fingerprint circuit 124 then transmits the corresponding fingerprint enrollment result to the wireless communication circuit 122, and the fingerprint enrollment result is sent to the operating system 140 through the wireless communication circuit 116, the protocol converter 114 and the fingerprint driver 112, to complete the fingerprint enrollment process.

On the other hand, if the operating system transmits an authentication request, the fingerprint circuit 124 may match (or compare) the collected fingerprint image with a previously enrolled fingerprint image to generate an authentication result. If the fingerprint is correct, the fingerprint circuit 124 may transmit the authentication result (which may include the corresponding user ID) to the wireless communication circuit 122, and the authentication result is sent to the operating system 140 through the wireless communication circuit 116, the protocol converter 114 and the fingerprint driver 112, to be provided to related applications for subsequent operations. In contrast, if the fingerprint is wrong, the fingerprint circuit 124 may also transmit the authentication result to the host device 110.

Note that the present invention aims at providing a solution for security verification technology of wireless fingerprint recognition that can transmit fingerprint data through a wireless communication interface and use an encrypted communication protocol to protect the transmitted fingerprint data and/or related information. Those skilled in the art may make modifications and alterations accordingly. For example, in the above embodiments, the wireless communication interface takes Bluetooth as an example. In other embodiments, another wireless communication interface may be applied to transmit fingerprint data, such as the Wireless Fidelity (Wi-Fi) or Long Range (LoRa) wireless transmission protocol, but not limited thereto. In addition, the fingerprint data and related information of the present invention on the transmission path are encrypted using an encrypted communication protocol to avoid information leakage and tampering. In the above embodiments, since the wireless communication system is built on the platform of the Windows operating system, the fingerprint security is required to comply with the SDCP protocol; hence, the system uses SDCP to encrypt the related fingerprint data/information. However, in other embodiments, if the wireless communication system applies another operating system or another platform, another encrypted communication protocol may be used to encrypt the fingerprint data/information.

To sum up, the present invention provides a fingerprint data processing method and related wireless communication system. The fingerprint data processing method allows the fingerprint data to be delivered between a host device and a wireless device through a wireless communication interface. The host device may be a computer host. The wireless device may be a peripheral device communicating with the computer host through the wireless communication interface, such as a wireless mouse. In an embodiment, the applied wireless communication interface is a Bluetooth interface. The host device may transmit the fingerprint recognition request to the wireless device through the wireless communication interface. The wireless device may correspondingly transmit the fingerprint data to the host device through the wireless communication interface, to realize the wireless fingerprint data transmission. In order to satisfy the security requirement of fingerprint data transmission, the present invention uses an encrypted communication protocol to protect the transmitted fingerprint data/information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fingerprint data processing method for a wireless communication system, the wireless communication system comprising a host device and a wireless device, which communicate with each other through a wireless communication interface, the fingerprint data processing method comprising:
generating, by the host device, a fingerprint recognition command;
driving, by the host device, a first wireless communication circuit to transmit a fingerprint recognition request to the wireless device through the wireless communication interface according to the fingerprint recognition command;
receiving, by the wireless device, the fingerprint recognition request through the wireless communication interface, and obtaining, by the wireless device, fingerprint data according to the fingerprint recognition request; and
driving, by the wireless device, a second wireless communication circuit to transmit the fingerprint data to the host device through the wireless communication interface;
wherein the wireless communication interface forwards at least one of the fingerprint recognition request and the fingerprint data using an encrypted communication protocol.

2. The fingerprint data processing method of claim 1, wherein the wireless communication interface comprises a Bluetooth interface, and each of the first wireless communication circuit and the second wireless communication circuit is a Bluetooth control circuit.

3. The fingerprint data processing method of claim 1, further comprising:
performing, by the wireless device, fingerprint collection through a fingerprint circuit according to the fingerprint recognition request, to obtain a fingerprint image as the fingerprint data to be transmitted to the host device.

4. The fingerprint data processing method of claim 3, further comprising:
storing, by the host device, the fingerprint image as an enrolled fingerprint image.

5. The fingerprint data processing method of claim 3, further comprising:
matching, by the host device, the fingerprint image with an enrolled fingerprint image to generate an authentication result.

6. The fingerprint data processing method of claim 1, further comprising:
performing, by the wireless device, fingerprint collection through a fingerprint circuit according to the fingerprint recognition request, to obtain a fingerprint image.

7. The fingerprint data processing method of claim 6, further comprising:
storing, by the wireless device, the fingerprint image as an enrolled fingerprint image, the enrolled fingerprint image being the fingerprint data to be transmitted to the host device.

8. The fingerprint data processing method of claim 6, further comprising:
matching, by the wireless device, the fingerprint image with an enrolled fingerprint image to generate an authentication result, the authentication result being the fingerprint data to be transmitted to the host device.

9. The fingerprint data processing method of claim 1, wherein the step of the host device driving the first wireless communication circuit to transmit the fingerprint recognition request to the wireless device through the wireless communication interface according to the fingerprint recognition command comprises:
generating a virtual interface built in an operating system of the host device;
transmitting the fingerprint recognition command to the first wireless communication circuit through the virtual interface; and
outputting, by the first wireless communication circuit, the fingerprint recognition request according to the fingerprint recognition command.

10. A host device comprising:
a fingerprint driver configured to generate a fingerprint recognition command;
a wireless communication circuit configured to transmit a fingerprint recognition request through a wireless communication interface and receive fingerprint data through the wireless communication interface; and
a protocol converter, coupled between the fingerprint driver and the wireless communication circuit, configured to drive the wireless communication circuit to output the fingerprint recognition request according to the fingerprint recognition command;
wherein the wireless communication interface forwards at least one of the fingerprint recognition request and the fingerprint data using an encrypted communication protocol.

11. The host device of claim 10, wherein the fingerprint data comprises a fingerprint image.

12. The host device of claim 11, wherein the fingerprint driver is configured to store the fingerprint image as an enrolled fingerprint image, or match the fingerprint image with the enrolled fingerprint image to generate an authentication result.

13. The host device of claim 10, wherein the fingerprint data comprises an authentication result, and the authentication result is generated by matching a collected fingerprint image with an enrolled fingerprint image.

14. The host device of claim 10, wherein the protocol converter comprises:
a virtual interface driver configured to generate a virtual interface built in an operating system of the host device; and
a service provider configured to communicate with the wireless communication circuit through the virtual interface, to transmit the fingerprint recognition command from the fingerprint driver to the wireless communication circuit through the virtual interface.

15. A wireless device, comprising:
a wireless communication circuit configured to receive a fingerprint recognition request through a wireless communication interface and transmit fingerprint data through the wireless communication interface; and
a fingerprint circuit, coupled to the wireless communication circuit, configured to generate the fingerprint data according to the fingerprint recognition request and transmit the fingerprint data to the wireless communication circuit;
wherein the wireless communication interface forwards at least one of the fingerprint recognition request and the fingerprint data using an encrypted communication protocol.

16. The wireless device of claim 15, wherein the wireless communication interface comprises a Bluetooth interface, and the wireless communication circuit is a Bluetooth control circuit.

17. The wireless device of claim 15, wherein the fingerprint data comprises a fingerprint image obtained through fingerprint collection performed by the fingerprint circuit.

18. The wireless device of claim 15, wherein the fingerprint circuit is configured to perform fingerprint collection to obtain a fingerprint image, and store the fingerprint image as an enrolled fingerprint image, wherein the fingerprint data comprises a fingerprint enrollment result corresponding to the enrolled fingerprint image.

19. The wireless device of claim 15, wherein the fingerprint circuit is configured to perform fingerprint collection to obtain a fingerprint image, and match the fingerprint image with an enrolled fingerprint image to generate an authentication result, wherein the fingerprint data comprises the authentication result.

20. The wireless device of claim 15, wherein the wireless device is a wireless mouse or a wireless keyboard.
